(19) United States
(12) Patent Application Publication
(10) Pub. No.: US 2009/0032990 A1
(43) Pub. Date: Feb. 5, 2009

(54) Extrusion Method and Extrusion Apparatus

(75) Inventor: Kari Kirjavainen, Tampere (FI)

Correspondence Address: OLIFF & BERRIDGE, PLC, P.O. BOX 320850, ALEXANDRIA, VA, 22320-4850, US

(73) Assignee: Maillefer S.A., Ecublens (CH)

(21) Appl. No.: 11/922,695

(22) PCT Filed: Jul. 3, 2006
(86) PCT No.: PCT/FI2006/050311

§ 371 Date: Feb. 5, 2008

(30) Foreign Application Priority Data
Jul. 4, 2005 (FI) 20055387

(51) Int. Cl. B29C 47/08; B29C 47/28

(52) U.S. Cl. 264/101; 264/209.8; 425/378.1; 425/380

(57) ABSTRACT

An extrusion apparatus is used for extruding material through a nozzle (10) for forming a product In the nozzle (10), the material is pressed around rods (9) so that tubular cavities (13) are formed in the wall of the product. The rods (9) are hollow and the apparatus comprises channels (14) connected to the hollow rods (9) to enable flow in the tubular cavities (13).

### BACKGROUND OF THE INVENTION

The invention relates to an extrusion method comprising extruding material through a nozzle, whereby the material is pressed around rods in the nozzle so that tubular cavities are formed in the wall of a product.

The invention further relates to an extrusion apparatus comprising means for feeding material, a nozzle for forming a product and rods arranged in connection with the nozzle for forming tubular cavities in the wall of a product.

U.S. Pat. No. 4,323,339 discloses a solution for making a plastic tube whose wall is provided with elongated cavities. The product is manufactured by an extruder whose nozzle comprises an annular retainer. The retainer is provided with rods around which material is pressed, whereby the rods form tubular cavities in the product walls.

### BRIEF DESCRIPTION OF THE INVENTION

The object of the invention is to provide a novel and improved extrusion method and extrusion apparatus.

The method according to the invention is characterized in that the rods are hollow and connected to the channels provided in the extrusion apparatus to enable flow through the tubular cavities, hollow rods and channels.

The apparatus according to the invention is characterized in that the rods are hollow and that the apparatus comprises channels connected to the hollow rods.

The invention is based on the idea that a product is extruded by supplying material to the extruder nozzle, where there are rods inside the material so that tubular cavities are formed inside the wall of the extruded object. The rods are hollow and connected to the channels leading through the extruder. This enables flow in the tubular cavities as well as the manufacture of a product with a good quality.

According to another embodiment, cooling air is sucked through the tubular cavities inside the wall of the object and through the hollow rods. In that case, a very large cooling surface is achieved and the product cools very efficiently. Furthermore, a very rapid cooling is achieved. If desired, energy can be recovered from the warm air sucked in cooling and utilized. In addition, steam, gas or moisture can be led away from inside the product efficiently, if desired.

### BRIEF DESCRIPTION OF FIGURES

The invention will be described in greater detail in the accompanying drawings, in which

FIG. 1 is a schematic and sectional side view of a part of an extrusion apparatus,

FIG. 2 is a schematic and sectional view of an extruded product seen from its end, and

FIG. 3 schematically illustrates the endpiece of the apparatus according to FIG. 1.

For the sake of clarity, the figures illustrate the invention in a simplified manner. Like reference numbers refer to like parts in the figures.

### DETAILED DESCRIPTION OF THE INVENTION

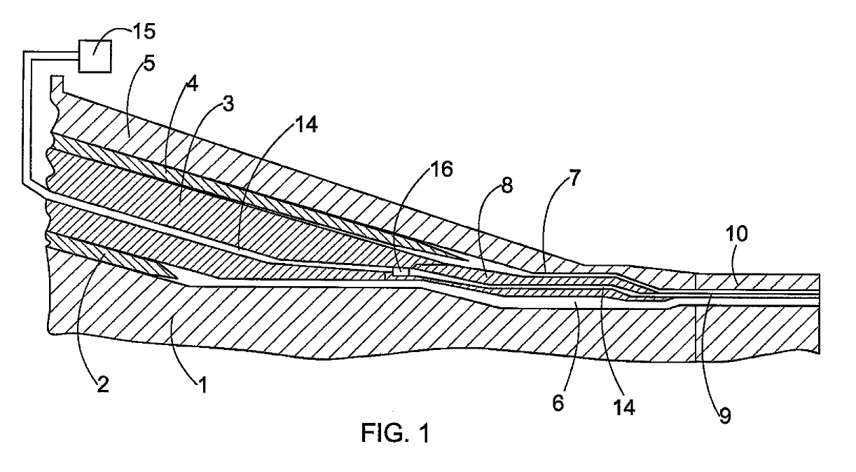

FIG. 1 illustrates an extrusion apparatus. The extrusion apparatus comprises an inner stator 1 and an inner stator 2 arranged outside the former, the inner stator 2 having the shape of a convergent cone. Outside the inner stator 2 there is an intermediate stator 3, and outside the intermediate stator 3 there is an outer rotor 4 having the shape of a convergent cone. Outside the outer rotor 4 there is an outer rotor 5. Between each rotor 2 and 4 and stator 1, 3 and 5 there is a feed gap where the material to be extruded flows as the rotors 2 and 4 are rotated.

By rotating the inner rotor 2, material is conveyed through an inner material channel 6 to a nozzle 10. Correspondingly, by rotating the outer rotor 4, material is conveyed along an outer material channel 7 to the nozzle 10.

For the sake of clarity, FIG. 1 does not show the devices for rotating the rotors 2 and 4 nor the devices for feeding material, by means of which the material to be extruded is fed inside and outside the rotors 2 and 4. Furthermore, for the sake of clarity FIG. 1 does not illustrate grooves which are provided in the stators 1, 3 and 5 and/or in the rotors 2 and 4 and which allow the material to flow out of the apparatus.

The intermediate stator 3 comprises an endpiece 8 attached immovably to its end. The endpiece 8 comprises rods 9 that extend inside the nozzle 10. The material to be extruded is pressed through the material channels 6 and 7 around the rods 9.

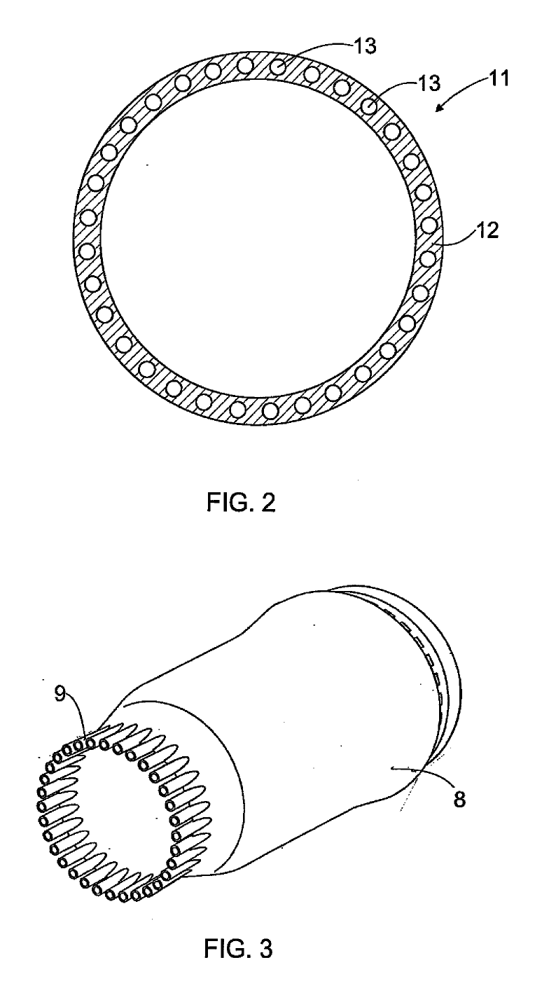

A product according to FIG. 2 is achieved by the apparatus according to FIG. 1. The product in question is a pipe 11. The wall 12 of the pipe 11 comprises tubular cavities 13. Such a product is relatively lightweight, yet having a rather good strength.

The rods 9 are hollow. A suction duct 14 leads from the rods 9 through the endpiece and the intermediate stator 3. The suction duct 14 leads to a pump 15, by means of which air is sucked. In other words, air is sucked through the tubular cavities 13 in the product into the hollow rods 9 and further therefrom along the suction ducts 14.

A suction duct 14 leads from each hollow rod 9 through the endpiece B. A connecting channel 16 is formed at the joining point of the endpiece 8 and the intermediate stator 3. The flows from the suction ducts 14 leading from the hollow rods 9 are combined in the connecting channel 16. One or more suction ducts 14 lead further from the connecting channel 16 to the pump 15. If there are 32 hollow rods 9 as in the case illustrated in FIG. 3, then 32 suction ducts 14 lead through the endpiece 8. After the connecting channel 16, four suction ducts, for example, are arranged through the intermediate stator 3. If desired, these suction ducts can be combined before the pump 15. The suction ducts 14 provided in the intermediate stator 3 are preferably arranged symmetrically therein. Furthermore, the connecting channel 16 is preferably annular, in which case it connects all suction ducts 14 of the endpiece 8 and all suction ducts 14 of the intermediate stator 3. The connecting channel 16 may also be made discontinuous by connecting eight suction ducts 14 of the endpiece 8 to one suction duct 14 of the intermediate stator 3, for instance. The connecting channel 16 equalizes pressure differences between different suction ducts 14.

By sucking air through the tubular cavities 13 provided inside the wall of the product, the extruded product can be cooled very efficiently because the cooling surface can be made large. The cooling speed will also be good. Furthermore, since suction takes place from inside the product wall, steam, gas or moisture discharged from the product material can be sucked away.

The air sucked from inside the product wall is rather warm, and if desired, this warm air can be utilized in heating the material to be fed into the extruder, for example. Heat can be recovered efficiently because the suction takes place in the direction opposite to the extrusion direction and thus the solution also functions as a counterflow heat exchanger.

FIG. 3 illustrates the structure of the endpiece 8. The endpiece 8 is a sleeve-like object, which is attached to the intermediate stator 3. If desired, the endpiece 8 and the intermediate stator 3 may also be integrated into one piece. On the other hand, the intermediate stator 3 and the other structures of the extrusion apparatus can be formed from several different pieces. For example, if the intermediate stator 3 is made of two pieces, the suction ducts 14 can be arranged to travel between these pieces.

The rods 9 are so long that the molten material has time to stiffen before the end of the rod, in which case tubular cavities 13 form in the desired manner. The rods 9 may extend to the end of the nozzle 10 as illustrated in FIG. 1. If desired, the rods 9 may extend even outside the nozzle or they may end before the end of the nozzle 10.

In some cases, the features presented in this application may be utilized as such regardless of the other features. On the other hand, the features presented in this application may be combined to form various combinations, if necessary.

The drawings and the related description are only intended to illustrate the inventive concept. The details of the invention may vary within the scope of the claims. Thus the product achieved by the described solution may be a pipe 11 comprising tubular cavities 13, as illustrated in FIG. 2. The product may further be for example a plate provided with tubular cavities or another corresponding product. The structure and shape of the product are determined by the structure of the endpiece and its rods and the nozzle. Furthermore, air is not necessarily sucked through the tubular cavities 13 in the product by the pump 15. The pump 15 may be arranged to blow air or another suitable gas or gas mixture through the suction ducts 14, hollow rods 9 and tubular cavities 13 in the product. In addition, all embodiments need not be provided with any suction or blow through the channels, hollow rods and tubular cavities. Also in that case, the channels, hollow rods and product cavities form an open connection, in which case pressures in the tubular cavities can equalize, for example, and the product will have an even quality. The apparatus disclosed is applicable to extruding plastics, such as polyolefins. The apparatus can further be used for extruding composite products, in which case wood fibre material, such as saw dust, and binder, such as plastic, are fed into the apparatus. In addition, various additives and auxiliary agents can naturally be fed into the apparatus at the same time. Recycled materials can also be extruded by the apparatus in question. For example, when composite products are extruded, moisture and/or gas and/or steam can be removed from inside the product by suction.

1-9. (canceled)

10. An extrusion method comprising extruding material through a nozzle, whereby the material is pressed around rods in the nozzle so that tubular cavities are formed in the wall of a product, which rods are hollow and connected to channels provided in the extrusion apparatus so as to enable flow through the tubular cavities, hollow rods and channels, wherein material is extruded by an apparatus comprising an intermediate stator, at least one feed gap outside it and at least one feed gap inside it, and that an endpiece is connected to the intermediate stator, the rods being arranged in the endpiece.

11. A method according to claim 10, wherein air is sucked through the tubular cavities in the product and hollow rods from inside the wall of the product to cool the product.

12. A method according to claim 10, wherein the channels are arranged through the intermediate stator.

13. A method according to claim 10, wherein the feed gaps have the shape of a convergent cone.

14. An extrusion apparatus comprising means for feeding material, a nozzle for forming a product, rods arranged in connection with the nozzle for forming tubular cavities, which rods are hollow, channels connected to the hollow rods, an intermediate stator, at least one feed gap arranged outside the intermediate stator, and an endpiece, which is connected to the intermediate stator, the rods being arranged in the endpiece.

15. An apparatus according to claim 14, wherein the apparatus comprises suction means for sucking cooling air through the tubular cavities in the product, hollow rods and channels.

16. An apparatus according to claim 14, wherein the channels are arranged in the intermediate stator.

17. An apparatus according to claim 14, wherein the feed gaps have the shape of a convergent cone.

18. An apparatus according to claim 14, wherein the apparatus comprises a connecting channel for combining the flows of the channels connected to the hollow rods.
